(19) United States
(12) Patent Application Publication
(10) Pub. No.: US 2006/0209140 A1
(43) Pub. Date: Sep. 21, 2006

(54) Inkjet recording apparatus

(75) Inventor: Masaru Nagai, Iruma-shi (JP)

Correspondence Address: LUCAS & MERCANTI, LLP, 475 PARK AVENUE SOUTH, 15TH FLOOR, NEW YORK, NY, 10016, US

(73) Assignee: Konica Minolta Holdings, Inc.

(21) Appl. No.: 11/370,120

(22) Filed: Mar. 7, 2006

(30) Foreign Application Priority Data
Mar. 15, 2005 (JP) JP2005-072665

(51) Int. Cl. B41J 2/175

(52) U.S. Cl. 347/85

(57) ABSTRACT

An inkjet recording apparatus, including a recording head including plural nozzles to jet ink and a ink chamber communicating with each of the plural nozzles, a hermetically closed ink tank, a hermetically closed ink supplying flow path to supply ink to the ink chamber, a hermetically closed ink discharging flow path to discharge ink from the ink chamber, a waste ink tank to store waste ink, and a changeover section to select a destination of the ink discharged through the ink discharging flow path, wherein the destination is either the ink or the waste ink tank.

This application is based on Japanese Patent Application No. 2005-072665, filed on Mar. 15, 2005 with the Japanese Patent Office, the entire content of which is hereby incorporated by reference.

### BACKGROUND OF THE INVENTION

The present invention relates to an inkjet recording apparatus.

In the past, to discharge air in inkjet heads or to refresh degenerated ink, pressure was applied onto ink in the inkjet heads, or ink was aspirated through a nozzle, but a significant amount of ink was discarded by these methods, which were disadvantageous. Specifically in recent years, since the number of nozzles have increased in higher speed recording conducted by lined heads, a great deal of ink has been wastefully discharged during operational recovery of the inkjet heads.

As methods to reduce the amount of wasted ink, many ink circulation systems have been offered on the market in which ink is circulated to discharge air in the inkjet heads, or to replace degenerated ink with new ink.

Circulation systems, used in an ink supplying system which is open to atmospheric air, have a long history, the fundamental structure of which is publicly known (see Patent Documents 1 and 2).

Further, in order to stably eject ink from the recording heads in the circulation system, to change the direction of pressurized transportation or to send ink to a waste ink tank, a valve is provided between the inkjet head and a pressurized transportation means, via which any foreign matters is removed (see Patent Document 3).

Patent Document 1: Unexamined Japanese Patent Application Publication No. 54-160242

Patent Document 2: Unexamined Japanese Patent Application Publication No. 55-121074

Patent Document 3: Japanese Registration Patent No. 3054115

However, according to the above proposals, specifically in an inkjet recording apparatus in which ink is supplied through a hermetically closed circulation system which is shut off from atmospheric air, when ink is firstly applied or when an empty ink tank is changed to a full one, a great deal of air enters and flows back in the ink flow path, thus it is very difficult to control the amount of dissolved air to a prescribed amount, and further, when ink is jetted from the ink head, cavitation is generated in the inkjet heads, which results in defective jetting of ink.

An object of the present invention is to provide an inkjet recording apparatus using the hermetically closed system for the ink supply, wherein the amount of dissolved air is reduced to prevent the defective jetting of ink due to cavitation while jetting ink so that ink is stably jetted from the head.

### SUMMARY OF THE INVENTION

The above-described problems of the present invention are overcome by the following:

Item 1 An inkjet recording apparatus, including:

a recording head incorporating plural nozzles to jet ink, and a ink chamber communicating with each of the plural nozzles;

a hermetically closed ink storage tank;

a hermetically closed ink supplying flow path to supply ink to the ink chamber; and

a hermetically closed ink discharging flow path to discharge ink from the ink chamber;

the inkjet recording apparatus, wherein ink discharged through the ink discharging flow path is re-circulated to the ink supplying flow path, which includes;

a waste ink tank to store waste ink; and

a switching section to select the destination of ink discharged through the ink discharging flow path, in which the destination is either the ink tank or the waste ink tank.

Item 2 The inkjet recording apparatus described in Item 1, further including:

a recording head having two ink chambers:

a hermetically closed ink supplying flow path to supply ink to one of the ink chambers; and

a hermetically closed ink discharging flow path to discharge ink from the other ink chamber.

Item 3 The inkjet recording apparatus described in Item 1 or 2, wherein the ink tank is a sub-tank.

Item 4 The inkjet recording apparatus described in any one of Items 1-3, wherein the ink tank is a flexible container.

Item 5 The inkjet recording apparatus described in any one of Items 1-4, wherein the ink supplying flow path includes an ink transportation means to transport ink.

Item 6 The inkjet recording apparatus described in any one of Items 1-5, wherein the ink discharging flow path includes an ink transportation means to transport ink.

Item 7 The inkjet recording apparatus described in Item 6, wherein the ink transportation means of the ink discharging flow path is able to reverse the ink transport direction.

Item 8 The inkjet recording apparatus described in any one of Items 1-7, further including:

an ink recovering means for recovering ink ejected from the plural nozzles; and

a waste ink tank for containing the ink recovered by the ink recovering means.

Item 9 The inkjet recording apparatus described in Item 8, wherein the waste ink tank, for containing the ink discharged through the ink discharging flow path, and the waste ink tank, for containing the ink recovered by the ink recovering means, are common.

### BRIEF DESCRIPTION OF THE DRAWINGS

FIG. 1 is a perspective view of the main sections of an inkjet recording apparatus related to the present invention.

FIG. 2 is a perspective view of an inkjet head of the inkjet recording apparatus related to the present invention.

FIG. 3 is a schematic diagram of the first embodiment of an ink supplying system related to the present invention.

FIG. 4 is a flowchart of the process of a primary ink feeding mode which is conducted by the inkjet recording apparatus as the first embodiment of the ink supplying system related to the present invention.

FIG. 5 is also a flowchart of the process of a long standby ink circulation mode which is conducted by the inkjet recording apparatus as the first embodiment of the ink supplying system related to the present invention.

FIG. 6 is a schematic diagram of the second embodiment of the ink supplying system related to the present invention.

FIG. 7 is a schematic diagram of the third embodiment of the ink supplying system related to the present invention.

FIG. 8 is another flowchart of the process of the primary ink feeding mode which is conducted by the inkjet recording apparatus as the third embodiment of the ink supplying system related to the present invention.

FIG. 9 is yet another flowchart of the process of the long standby ink circulation mode which is conducted by the inkjet recording apparatus as the third embodiment of the ink supplying system related to the present invention.

FIG. 10 is a schematic diagram of the fourth embodiment related to the present invention.

FIG. 11 is a schematic diagram of the fifth embodiment related to the present invention.

FIG. 12 is another perspective view of the inkjet heads of the inkjet recording apparatus related to the present invention.

### DETAILED DESCRIPTION OF THE PREFERRED EMBODIMENTS

The embodiments of the present invention will now be detailed while referring to the drawings. These descriptions of the present section do not limit the technical scope nor the meaning of terms in the claims. Further, specific descriptions in the embodiments of the present invention show the best mode, which also do not limit the meaning of the terms nor the technical scope of the present invention.

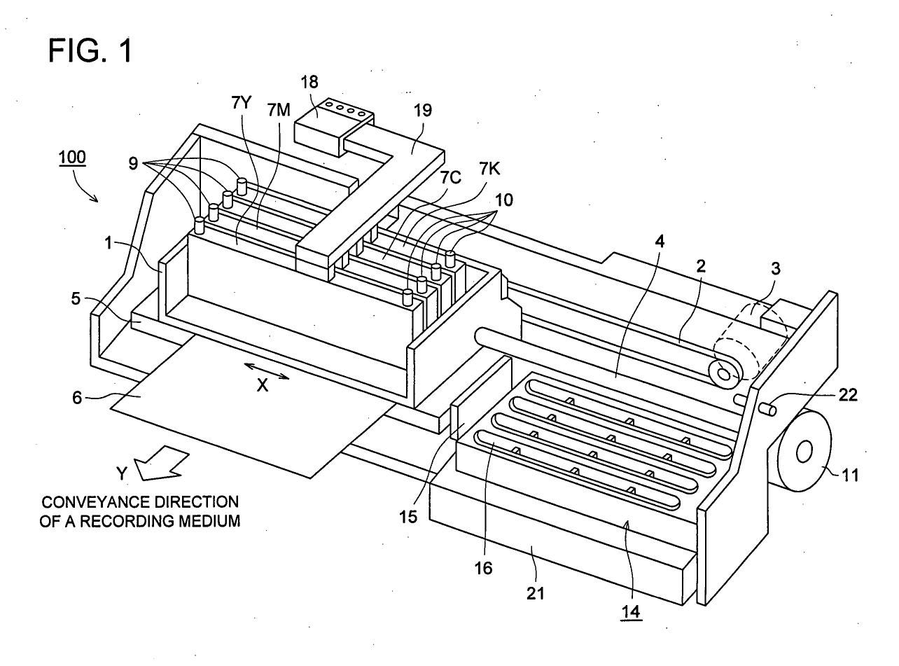

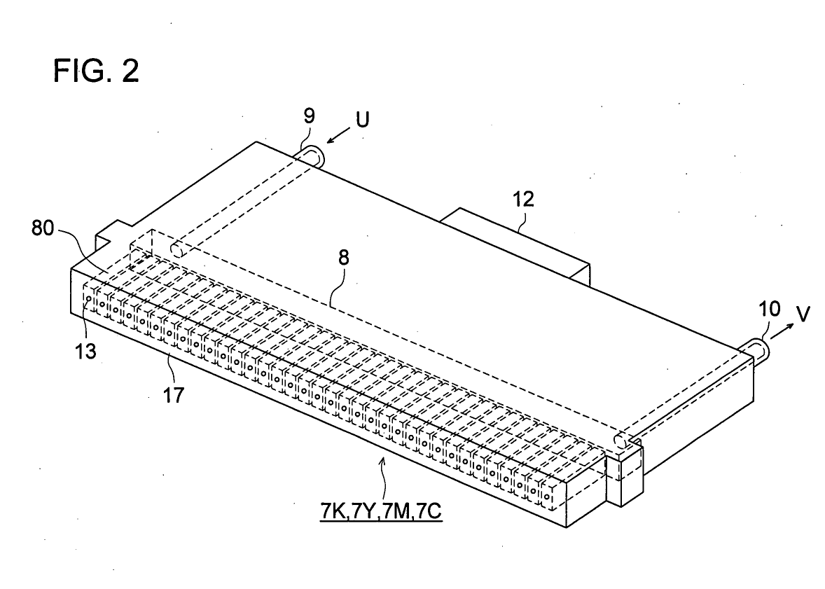

The detailed embodiments refer to FIG. 1, which is a perspective view of the main sections of the inkjet recording apparatus related to the present invention, and also refer to FIG. 2 which is a perspective view of the inkjet head used in the described inkjet recording apparatus.

In inkjet recording apparatus 100, numeral 1 represents a carriage, which is associated with a part of timing belt 2, reversibly driven by rotation of carriage motor 3, and guided by guide member 4, whereby carriage 1 is structured to reversibly move parallel to platen 5.

Numerals 7K, 7C, 7M, and 7Y, in FIG. 1, represent inkjet heads to eject black ink, cyan ink, magenta ink and yellow ink, respectively, incorporating plural nozzles 13, in FIG. 2, to jet ink, and are formed perpendicular to the conveyance direction of recording medium 6. These inkjet heads are integrally structured with carriage 1.

Plural pressure chambers 80 are provided in inkjet heads 7K, 7C, 7M and 7Y, which are barrel-shaped and compartmented by side walls. Each end is communicated with ink chamber 8 to feed ink. Each of the other ends of pressure chambers 80 is communicated with plural nozzles 13 formed on nozzle surface 17, and ink is pressurized in each of pressure chamber 80 by a pressure generating means (which is not illustrated)), such as a piezoelectric element, whereby ink is ejected from each nozzle 13.

A supply port and a discharge port are formed on the upper section of ink chamber 8. The supply port is communicated with first connector 9, while the discharge port is communicated with second connector 10, whereby ink chamber 8 is structured to serve as a section of an ink circulating path.

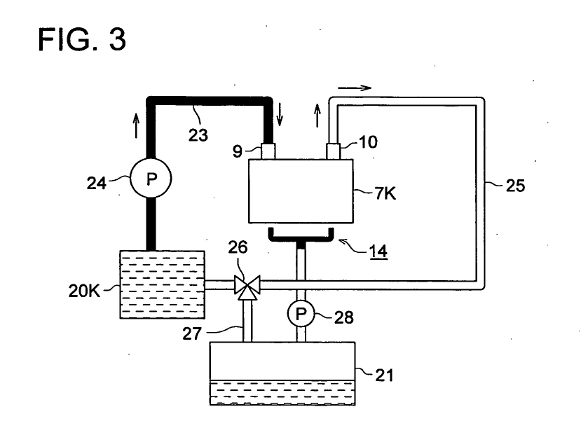

Plural nozzles 13, to jet ink, are arranged facing platen 5, and cause the images to be printed onto recording medium 6. As shown by arrows U and V in FIG. 2, ink is supplied to inkjet heads 7K, 7C, 7M and 7Y through first connectors 9, while ink is returned to ink tanks 20 (see FIG. 3) for each color ink, through second connectors 10 from ink chambers 8 (see FIG. 2) in the inkjet head for each color ink.

Recording medium 6 is conveyed in arrowed direction Y by the rotation of a conveyance roller, which is not illustrated.

Numeral 11 represents a conveyance motor which drives the conveyance roller at a predetermined rotation rate.

Numeral 14, located outside the area where recording medium 6 is conveyed, represents a capping section to cover nozzle surfaces 17 of inkjet heads 7K, 7C, 7M and 7Y. Further, capping section 14 functions as an ink recovering section to recover any jetted ink from inkjet heads 7K, 7C, 7M and 7Y.

Numeral 15 represents a cleaning section, which touches and cleans nozzle surfaces 17 of inkjet heads 7K, 7C, 7M and 7Y, as carriage 1 reciprocates. Further, in the same way as capping section 14, cleaning section 15 is installed outside the area where recording medium 6 is conveyed, and is installed more adjacent than capping section 14 to the area where recording medium 6 is conveyed.

Numeral 18 represents a control section including a CPU (central processing unit) and a working memory, which controls various operations of inkjet recording apparatus 100, such as rotation of the conveyance roller, the movements and ink jetting of inkjet heads 7K, 7C, 7M and 7Y, and capping movement of capping section 14. Further, control section 18 is structured to control the primary ink feeding mode, the long standby ink circulation mode, and the short standby ink circulation mode related to the present invention.

Numeral 19 represents cables to connect connector 12 (FIG. 2) of inkjet heads 7K, 7C, 7M and 7Y to control section 18.

Numeral 20, in FIG. 3, represents a flexible ink tank which does not employ an atmospheric discharge hole, and ink tank 20 stores only de-aerated ink, and ink is circulated through a hermetically closed ink flow path.

Numerals 21 represents waste ink tanks to store ink which was preliminarily jetted from inkjet heads 7K, 7C, 7M and 7Y, and was recovered by capping section 14.

Numeral 22 represents a home position sensor, being a photoelectrical sensor, which detects a side surface of carriage 1, and detects a waiting position of carriage 1 where nozzle surfaces 17 of inkjet heads 7K, 7C, 7M and 7Y are covered by capping section 14.

When inkjet recording apparatus 100 starts image recording, based on control signals emitted from control section 18 showing the start of recording, inkjet heads 7K, 7C, 7M and 7Y located at the capping position are moved to the start position in the image recording area by carriage motor 3, where their positions are fixed. When electrical signals based on the image data from control section 18 are applied to inkjet heads 7K, 7C, 7M and 7Y, ink droplets of each color are jetted from the prescribed nozzles of inkjet heads 7K, 7C, 7M and 7Y, so that the images are recorded on recording medium 6 resting on platen 5. Recording medium 6 is conveyed in the arrowed direction, synchronizing with jetting of ink from inkjet heads 7K, 7C, 7M and 7Y, and the image recording operation is continued till the predetermined image data are processed.

Next, the first embodiment of the ink supplying flow path and ink discharging flow path related to the present invention will be detailed, while referring to FIG. 3, which is a schematic drawing showing the first embodiment of the ink supplying system integrated into the inkjet recording apparatus related to the present invention. Supplying flow path 23, and discharging flow path 25 are sealed from atmospheric air. De-aerated ink is used in this system.

In addition, the ink supplying systems are operated in the same way for each of black, cyan, magenta and yellow color ink. However, only black ink will be used in the descriptions.

Pump 24 is provided in supplying flow path 23 to send ink to inkjet head 7K under pressure from black ink tank 20K to first connector 9 of inkjet head 7K. That is, ink tank 20K, supplying flow path 23 and pump 24 work together to form the ink supplying means.

Changeover valve 26, functioning as a changeover means, is provided in discharging flow path 25 through which ink is returned from second connector 10 to ink tank 20K, and further, ink wasting flow path 27 is formed between changeover pump 26 and waste ink tank 21. When changeover valve 26 is operated to change the direction of ink flow, ink on the way to return to ink tank 20K through discharging flow path 25, is caused to enter ink wasting flow path 27 through changeover valve 26, and then sent to waste ink tank 21.

Further, suction pump 28, provided on the flow path between capping section 14 and waste ink tank 21, sucks ink from capping section 14 or nozzles 13 of inkjet head 7K, and sends it to waste ink tank 21.

In the normal ink supplying operation, until an ink level detector, which is not illustrated, detects no ink in ink tank 20K, ink is supplied via pump 24 from ink tank 20K to inkjet head 7K.

In addition, the back pressure of nozzle 13 of inkjet head 7K is structured to be directly formed at the position of ink tank 20K. Flexible ink tank 20K is positioned under the position of nozzle 13. Since the ink in ink tank 20K is under atmospheric pressure, if ink tank 20 K is positioned lower than nozzle 13 for a predetermined height, the ink pressure in nozzle 13 is lower than the atmospheric pressure by a predetermined pressure head value, and the ink can be stably ejected.

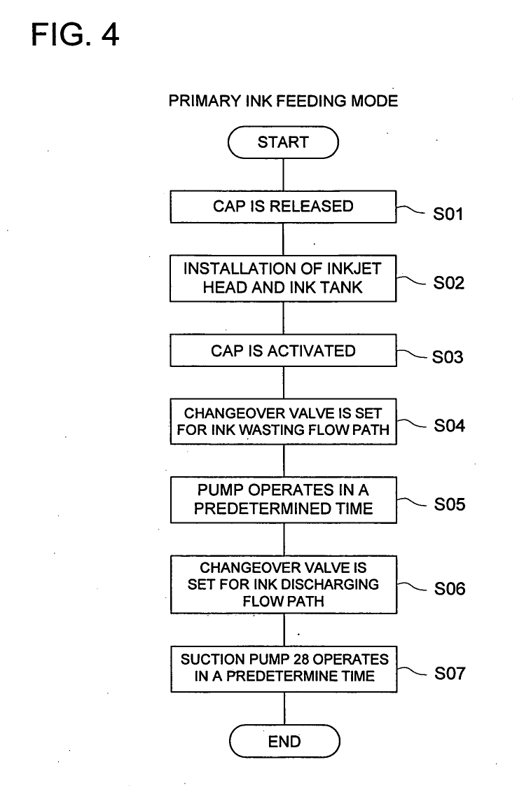

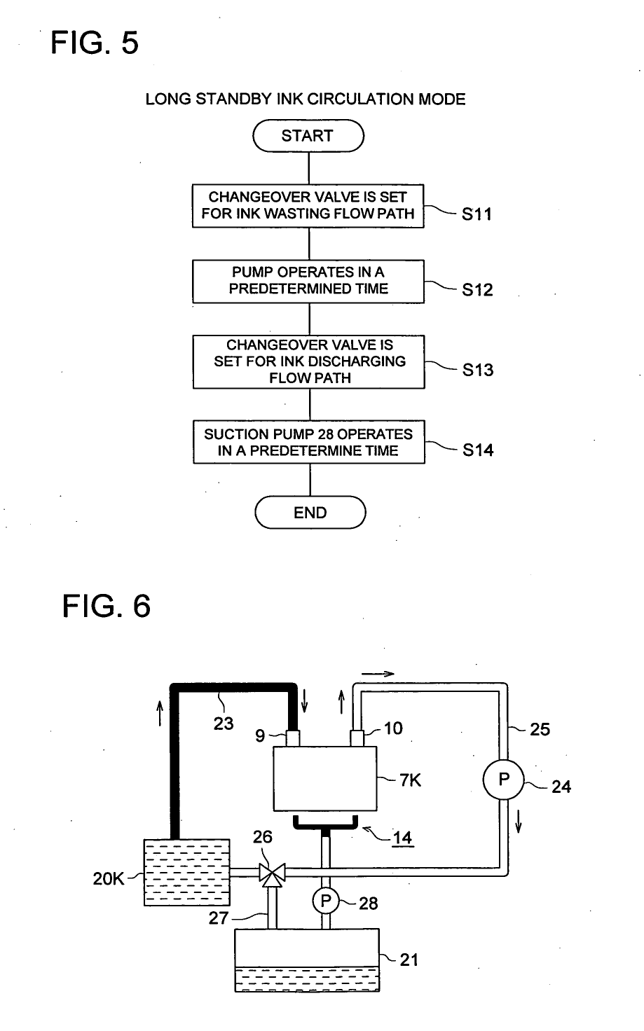

In the ink supplying system related to the first embodiment which is structured as described above, a problem exists in the present invention, that is, a great deal of air is returned into the ink tank, being a part of the circulation system, and thereby the amount of dissolved air in the ink increases, and cavitation readily occurs while the inkjet head jets ink. This can be overcome by an operation, which will be explained referring to the flowcharts of FIGS. 4 and 5.

The flowchart in FIG. 4 shows the processing flow of the primary ink feeding mode which is conducted in inkjet recording apparatus 100. The primary ink feeding mode is used when the apparatus is firstly installed or when the head is changed. In addition, the flowcharts of FIGS. 4 and 5 show the condition when electrical power has been supplied to inkjet recording apparatus 100, and in this condition, it is assumed that cap 16 (see FIG. 1) is already in close contact with nozzle surfaces 17 (see FIG. 2) of inkjet heads 7K, 7C, 7M and 7Y via capping section 14. Further, it is assumed that changeover valve 26 is open to allow ink flow through discharging flow path 25.

In FIG. 4, in step S01, capping section 14 is operated to release cap 16 from inkjet head 7K. In step S02, inkjet head 7K and ink tank 20K are installed. In step S03, capping section 14 is operated so that cap 16 comes into close contact with nozzle surface 17 of inkjet head 7K. In step S04, changeover valve 26 is switched to allow ink to flow through ink wasting flow path 27. In step S05, pump 24 is activated for a predetermined time. Any air remaining in ink wasting flow path 27 is not returned to ink tank 20K, but is sent in the directions shown by the arrows in FIG. 3 to enter waste ink tank 21. In step S06, changeover valve 26 is activated to feed ink into discharging flow path 25, and in step S07, suction pump 28 is operated in a predetermined time so that ink fills pressure chamber 80 and nozzles 13, whereby the primary ink feeding mode is completed.

The flowchart of FIG. 5 shows the process flow of the long standby ink circulation mode which is conducted by inkjet recording apparatus 100. When apparatus 100 is not operated for a relatively long time, the long standby ink circulation mode is used to resume the circulation of ink. If ink stays for a long time in supplying flow path 23, discharging flow path 25, ink wasting flow path 27 and ink chamber 8, the desired physical characteristics of the ink deteriorate. By the long standby ink circulation mode, such deteriorated ink is discharged into waste ink tank 21, while ink exhibiting prescribed characteristics stored in ink tank 20 is fed into supplying flow path 23, discharging flow path 25, ink wasting flow path 27 and ink chamber 8. The long standby ink circulation mode can be operated by the operator, or can be automatically operated by a timer, which is not illustrated, when the timer detects that a predetermined period of time has passed. In addition, the flowchart of FIG. 5 shows the condition when electrical power has been supplied to inkjet recording apparatus 100, and in this condition, it is assumed that cap 16 is already in close contact with nozzle surfaces 17 of inkjet heads 107K, 107C, 107M and 107Y via capping section 14. Further, it is assumed that changeover valve 26 is switched on to feed ink through discharging flow path 25.

In step S11 of FIG. 5, changeover valve 26 is opened to allow ink to flow through ink wasting flow path 27. In step S12, pump 24 is activated for a predetermined time so that any deteriorated ink remaining in supplying flow path 23, discharging flow path 25, ink wasting flow path 27 and ink chamber 8 is not returned to ink tank 20K, but is discharged into waste ink tank 21. In step S13, changeover valve 26 is switched from ink wasting flow path 27 to discharging flow path 25, and in step S14 suction pump 28 is operated in a predetermined time so that ink fills pressure chamber 80 and nozzles 13, which completes the long standby ink circulation mode process of FIG. 5.

When apparatus 100 is not operated for a short time, the short standby ink circulation mode is used for resumed circulation of ink after the short standby. The object of this mode is to feed slightly deteriorated ink remaining in ink chamber 8 into waste ink tank 21, and to fill fresh ink stored in ink tank 20 into ink chamber 8. The short standby ink circulation mode can be operated by the operator, or can be automatically operated by a timer, when the timer detects that a predetermined period of time has passed. Firstly, cap 16 is allowed to be in close contact with nozzle surface 17 of inkjet head 7K. Pump 24 is operated in a predetermined time, after changeover valve 26 is changed to discharging flow path 25. Any slightly deteriorated ink remaining in ink chamber 8 is fed into ink tank 20K, and mixed with the fresh ink. In this case the amount of the remaining ink is very few compared to the amount of the fresh ink, therefore the ink jetting stability is not deteriorated. By this operation, ink in ink chamber 8 is replaced with the fresh ink, and ink is not largely consumed. Accordingly, normal ink is always sent into the inkjet head, and ink is stably ejected by the short standby ink circulation mode.

Next, a second embodiment concerning the ink supplying flow path and discharging flow path related to the present invention will be detailed, while referring to FIG. 6, which shows the second embodiment of the ink supplying system applicable to the inkjet recording apparatus related to the present invention. Supplying flow path 23 and discharging flow path 25 are sealed from atmospheric air. De-aerated ink is also used in the system of FIG. 6.

Black ink will be used for these explanations. Supplying flow path 23 sends ink from black ink tank 20K to first connector 9 of inkjet head 7K.

Pump 24 for sending ink under pressure is provided in discharging flow path 25 through which ink is fed to ink tank 20K. That is, discharging flow path 25 and pump 24 operate as an ink discharging means in the present embodiment.

As shown in this embodiment, since pump 24 is provided in discharging flow path 25, it is not necessary to provide a pump in supplying flow path 23, and the back pressure control of nozzle 13 is easily operated. In addition, any undesirable air bubbles are effectively discharged.

Changeover valve 26 operates as a switching section between pump 24 of discharging flow path 25 and ink tank 20K, and ink wasting flow path 27 is formed between changeover valve 26 and waste ink tank 21. When changeover valve 26 is operated to change the ink flow direction, any ink, which was previously directed to ink tank 20 through discharging flow path 25, enters ink wasting flow path 27 through changeover valve 26, and is discharged into waste tank 21.

Further, suction pump 28 provided on the flow path between capping section 14 and waste ink tank 21, sucks any ink in capping section 14 or nozzles 13 of inkjet head 7K, and sends it to waste ink tank 21.

Since the operation of the ink supplying system described above is the same as the operation shown in the flowcharts in FIGS. 4 and 5, the explanation is omitted.

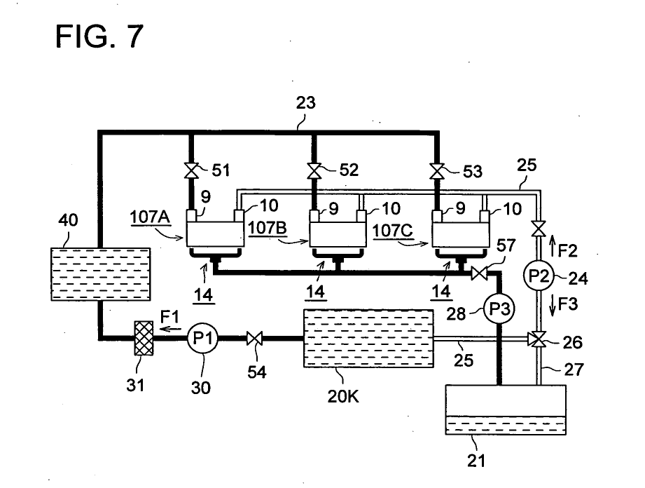

Next, a third embodiment of the ink supplying flow path and ink discharging flow path related to the present invention will be detailed, while referring to FIG. 7, which shows the third embodiment of the ink supplying system applicable to the inkjet recording apparatus related to the present invention. Plural inkjet heads are used for a single ink tank in this embodiment. Supplying flow path 23 and discharging flow path 25 are sealed from atmospheric air. De-aerated ink is also used in this system.

Black ink will again be used for these explanations. In order to stabilize the pressure applied onto ink in the nozzle sections of the inkjet heads, sub-tank 40, formed of a flexible bag, is provided in supplying flow path 23, which is from black ink tank 20K to first connectors 9 of inkjet heads 107A, 107B and 107C. Further, valve 54, pump 30 which sends pressurized ink from ink tank 20K to sub-tank 40, and filter 31 are provided between ink tank 20K and sub-tank 40. Valves 51, 52 and 53 are provided between sub-tank 40 and each of connectors 9. Pump 24, provided in discharging flow path 25, sends ink from second connectors 10 to ink tank 20K, as well as changeover valve 26 is provided between pump 24 and ink tank 20K, and thus ink wasting flow path 27 is formed from changeover valve 26 to waste ink tank 21. When changeover valve 26 is operated to change the ink flow from flow path 25 to flow path 27, any ink which was directed to ink tank 20K through discharging flow path 25 enters ink wasting flow path 27 through changeover valve 26, and then enters waste ink tank 21. Still further, valve 57 and suction pump 28 are provided in the flow path between capping section 14 and waste ink tank 21, whereby, any ink remaining in capping section 14 or nozzles 13 of inkjet heads 107A, 107B and 107C can be suctioned and fed into waste ink tank 21.

In the present embodiment, the back pressure of nozzle 13 of each head is determined by sub-tank 40, which is commonly provided for the plural heads. It is preferable that sub-tank 40 is commonly provided for all heads like this case. If sub-tank 40 is provided for each head, ink jetting would vary among the heads, due to positional difference of sub-tanks 40, which may result in a change of any printed color. A remaining ink amount detector or an empty detector is installed in sub-tank 40, and when the ink amount becomes less than a predetermined amount, valve 54 is opened and ink is replenished from ink tank 20 to sub-tank 40. Further, if ink is not replenished into sub-tank 40 at a predetermined time after valve 54 was opened, ink tank 20 is detected as an empty. Comparing to the method in which the back pressure is determined by the position of ink tank 20, the method described in this embodiment has merits in which the change of back pressure is not influenced by the change of the amount of remaining ink, as well as the empty condition of ink tank 20 can be detected. Further, even when ink tank 20 is to be replaced, printing operation is not stopped, because enough ink in the sub tank 40 can be used for printing, that is, replacing operation of ink tank 20 and the printing operation can be performed at the same time.

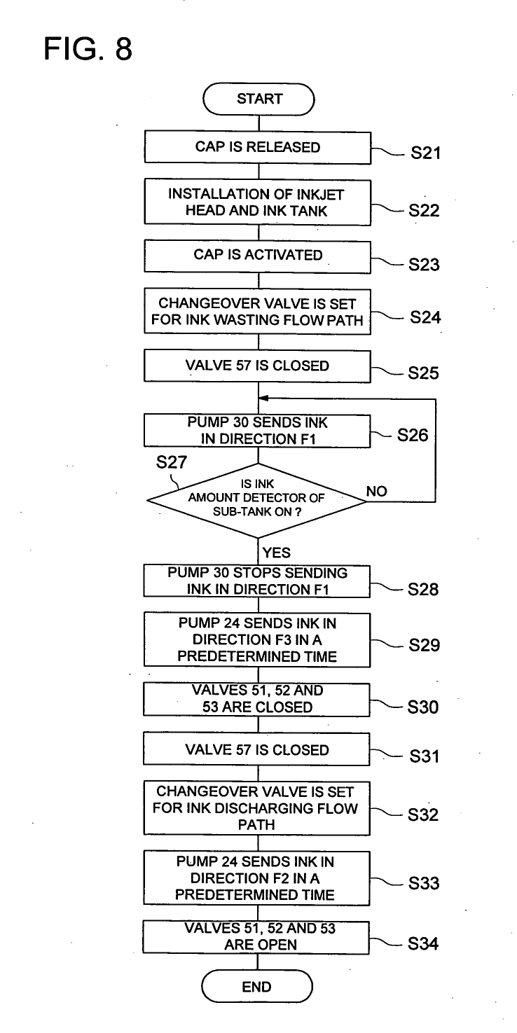

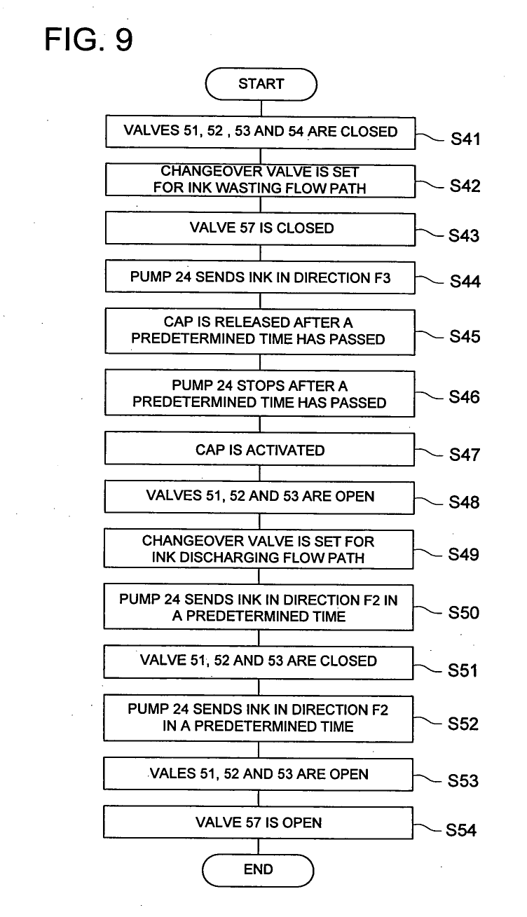

The operation of the ink supplying system described as above will be detailed referring to the flowcharts in FIGS. 8 and 9. The flowchart of FIG. 8 shows the processing flow of the primary ink feeding mode which is conducted in inkjet recording apparatus 100. The primary ink feeding mode is used when the apparatus is initially installed and/or when a head is changed. In addition, the flowcharts in FIGS. 8 and 9 show the condition when electrical power has been supplied to inkjet recording apparatus 100, and in this condition, it is assumed that cap 16 is already in close contact with nozzle surfaces 17 of inkjet heads 107K, 107C, 107M and 107Y via capping section 14. Further, it is assumed that changeover valve 26 is switched to feed ink through discharging flow path 25.

In step S21 of FIG. 8, capping section 14 is operated to release cap 16 from contact with nozzle surfaces 17. In step S22, inkjet heads 107A, 107B and 107C, and ink tank 20K are installed, while in step S23, capping section 14 is operated to set cap 16 into the primary position (cap 16 is in close contact with nozzle surfaces 17). In step S24, changeover valve 26 is switched to feed ink into ink wasting flow path 27. In step S25, valve 57 is closed. In step S26, pump 30 sends ink in direction F1, and in step S27, an ink amount sensor, which is not illustrated, detects the amount of ink in sub-tank 40 and checks whether a predetermined amount of ink has been stored in sub-tank 40. If not enough is stored (S27: NO), pump 30 continues to operate. If enough has been stored (S27: YES), pump 30 stops in step S28. In step S29, pump 24 is operated to feed ink in direction F3 for a predetermined time. Via this operation, any air in the ink flows, as well as ink which was previously stored in inkjet heads 107A, 107B and 107C during shipment from the factory, is discharged into waste ink tank 21. Further, ink stored in ink chamber 8 is also replaced by new ink from ink tank 20K. In step S30, valves 51, 52 and 53 are closed, while in step S31, valve 57 is open, and in step S32, changeover valve 26 is operated to allow ink flow through discharging flow path 25. In step S33, pump 24 is switched to feed ink in direction F2 for a predetermined time. This operation fills ink, which has been fully stored in the flow paths to ink chamber 8, to pressure chambers 80 and nozzles 13 by pump pressure. In step S34, valves 51, 52, 53 and 57 are opened to complete the primary ink feeding mode.

The flowchart in FIG. 9 shows the processing flow of the long standby ink circulation mode which is conducted by inkjet recording apparatus 100. When apparatus 100 has been idle for a long time, the long standby ink circulation mode is used for the initial circulation of ink after the long standby. If ink stays for a long time in supplying flow path 23, discharging flow path 25, ink wasting flow path 27 and ink chamber 8, the physical characteristics of the ink deteriorate. During the long standby ink circulation mode, such deteriorate ink is fed into waste ink tank 21, while ink exhibiting the prescribed characteristics stored in ink tank 20 is supplied into supplying flow path 23, discharging flow path 25, ink wasting flow path 27 and ink chamber 8. This mode can be operated by the operator, or automatically accomplished by a timer, which is not illustrated, when the timer detects that the predetermined time has passed. In addition, it is assumed that in the flow chart of FIG. 9, cap 16 is already in close contact with nozzle surfaces 17 of inkjet heads 7K, 7C, 7M and 7Y via capping section 14. Further, it is assumed that changeover valve 26 is open to allow ink flow through discharging flow path 25. The other valves are in the open condition.

In step S41, valves 51, 52, 53 and 54 are closed. In step S42, changeover valve 26 is switched to feed ink through ink wasting flow path 27. In step S43, valve 57 is closed, and in step S44, pump 24 is started to feed ink in direction F3. In step S45, the prescribed time has passed after pump 24 is operated, and the interior pressure is reduced in ink chamber 8, whereupon capping section 14 is operated to release cap 16 from nozzle surfaces 17, that is, the close contact condition between cap 16 and nozzle surfaces 17 is released, and ambient air enters from nozzles 13 to send any deteriorate ink in ink chamber 8 and inkjet heads 107A, 107B and 107C into waste ink tank 21. In step S46, when a prescribed time has passed after cap 16 is released, pump 24 is deactivated. In step S47, capping section 14 is operated so that cap 16 comes into close contact with nozzle surfaces 17. In step S48, valves 51, 52 and 53 are opened, and in step S49, changeover valve 26 is switched to allow ink to feed into discharging flow path 25. In step S50, pump 24 is operated for a predetermined time so that ink is sent in direction F3. By this operation, any ink remaining in the flow paths or in ink chamber 8 is replaced by the circulation with ink supplied from ink tank 20K. In step S51, valves 51, 52 and 53 are closed, and in step S52, pump 24 is operated for a predetermined time so that ink is sent in direction F2. This operation is conducted to fill ink, which has been fully stored in the flow path including ink chamber 8, to pressure chamber 80 and nozzles 13 by pump pressure. In step S53, valves 51, 52 and 53 are opened, and in step S54, valve 57 is opened to complete the long standby ink circulation mode.

Further, as the same manner as the above case, when the apparatus 100 is not operated for a short time, the short standby ink circulation mode is conducted for the first ink circulation.

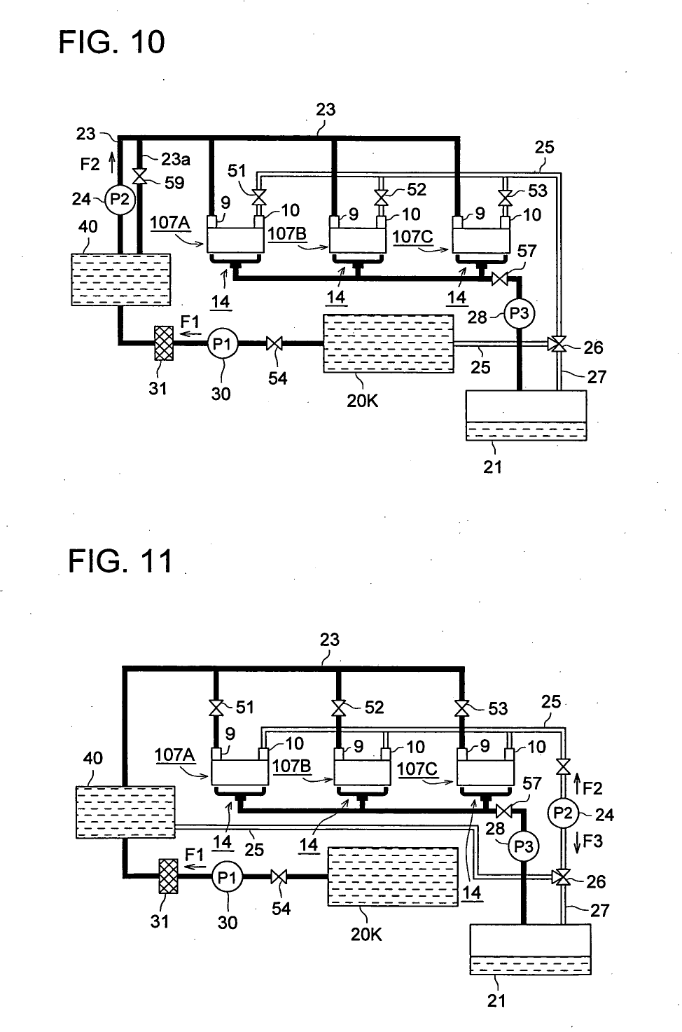

The fourth embodiment related to the present invention is detailed below. FIG. 10 is a schematic diagram of the fourth ink supplying system related to the present invention, wherein plural inkjet heads are used for a single ink tank. Supplying flow path 23 and discharging flow path 25 are sealed from ambient air. De-aerated ink is used in this system.

In FIG. 10, black ink is also used for the explanation of the fourth embodiment. In order to stabilize the pressure applied onto ink in the nozzle sections of the inkjet heads, sub-tank 40 formed of a flexible bag is provided on supplying flow path 23 which is from black ink tank 20K to inkjet heads 107A, 107B and 107C. Further, valve 54, pump 30 to send ink with pressure from ink tank 20K to sub-tank 40, and filter 31 are provided between ink tank 20K and sub-tank 40. Pump 24 is provided in supplying flow path 23 through which ink is sent from sub-tank 40 to each of first connectors 9. Flow path 23a is provided between sub-tank 40 and each of connectors 9, wherein valve 59 is provided in flow path 23a which is parallel to pump 24. Valve 59 remains open while normal printing operation. Flow path 23a operates as an ink supplying flow path to supply ink to inkjet heads 107A, 107B and 107C.

Changeover valve 26 is provided in discharging flow path 25 through which ink is returned from second connectors 10 to ink tank 20K, wherein changeover valve 26 switches the flow path from discharging flow path 25 to ink wasting flow path 27. Valves 51, 52 and 53 are provided between second connectors 10 and changeover valve 26. Ink wasting flow path 27 is formed from changeover valve 26 to waste ink tank 21. By switching changeover valve 26, ink, which was directed to ink tank 20K through discharging flow path 25, feeds into ink wasting flow path 27, and further, enters waste ink tank 21.

Suction pump 28 is provided in the flow path between capping section 14 and waste ink tank 21, which sucks ink in capping section 14 and/or nozzles 13 of inkjet heads 107K, 107B and 107C, and sends it to waste ink tank 21.

The fifth embodiment for supplying ink related to the present invention is detailed below. Supplying flow path 23 and discharging flow path 25, using de-aerated ink, are sealed from ambient air. Ink is returned from second connectors 10 to sub-tank 40 in this fifth embodiment shown in FIG. 11, though ink is returned from second connectors 10 to ink tank 20K through discharging flow path 25, in the third embodiment shown in FIG. 7. That is, sub-tank 40 functions as ink tank 20K in embodiments 1-4. Further, pump 24.and changeover valve 26 to switch to ink wasting flow path 27 are provided in discharging flow path 25, and further, ink wasting flow path 27 is formed between changeover valve 26 and waste ink tank 21.

In the third to fifth embodiments, the primary ink circulation mode, the long standby ink circulation mode and the short standby ink circulation mode are conducted for all inkjet heads. However, these modes can be conducted for the optional heads selected as occasion demands, through operating valves 51, 52 and 53 relating to each head (that is, any valves relating to the heads to which the mode is not conducted, are closed, while one mode is conducted). By this structure, ink is not wasted, and failure of ejection of ink is prevented.

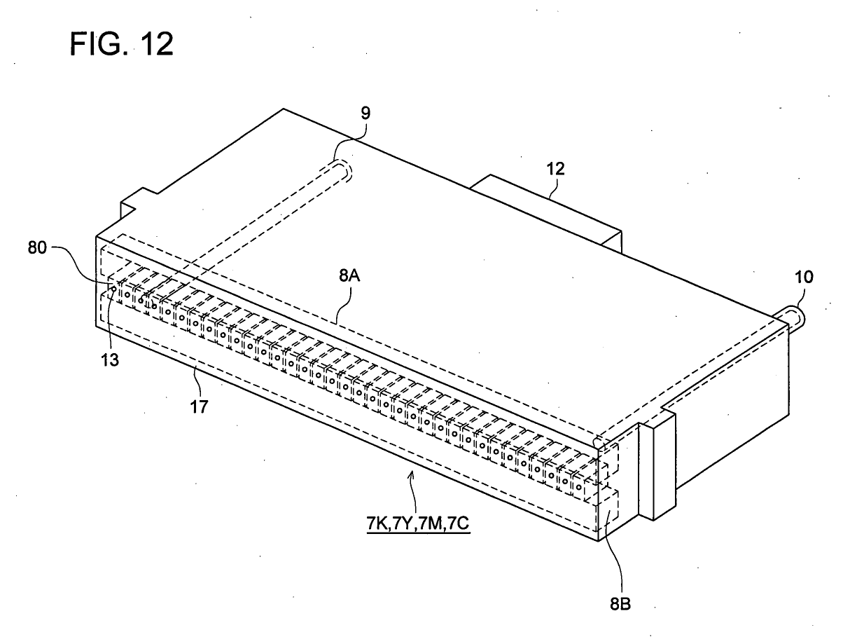

In the first to fifth embodiments, the head of an edge shooter type, shown in FIG. 2, is used for the explanation, however the present invention is not limited to this type, and for example, the head of a side shooter type can be used, as shown in FIG. 12. In FIG. 12, the same numerals are given to the structures exhibiting the same function as the head of FIG. 2, whereby any overlapping explanation is omitted.

In FIG. 12, plural pressure chambers 80 are provided in inkjet heads 7K, 7C, 7M and 7Y, which are barrel-shaped and compartmented by side walls. Each end is communicated with ink chamber 8A, while the other ends of pressure chambers 80 are communicated with ink chamber 8B to feed ink. The side surface of each pressure chamber 80 is communicated with plural nozzles 13 formed on nozzle surface 17, and ink is pressured in each pressure chamber 80 by a pressure generating means (which is not illustrated), such as a piezoelectric element, after which ink can be individually ejected from each nozzle 13.

A supply portion is formed on the upper section of ink chamber 8B, while a discharge portion is formed on the upper section of ink chamber 8A. The supply portion of ink chamber 8B is communicated with first connector 9, while the discharge portion of ink chamber 8A is communicated with second connector 10. Ink chambers 8A, 8B, and pressure chambers 80 form a part of the ink circulation path. By this formation, the desired effects of this invention are increased.

Ink of each color is supplied to inkjet heads 7K, 7C, 7M and 7Y through ink connectors 9, and ink is returned from ink tank 8B to ink tank 20 or intermediate tank 40 related to each color through each pressure chamber 80, ink chamber 8A, and second connector 10.

Further, in the first to fifth embodiments, after ink is filled, small amounts of air or deteriorated ink may remain in discharging flow path 25 between changeover valve 26 and ink tank 20 or sub-tank 40. Accordingly, the length of discharging flow path 25 should be as shorter as possible, and less than 10 cm is preferable.

Yet further, in the first to fifth embodiments, pump 24 is deactivated while printing operation so that any back pressure can be more easily controlled. Yet further, in this case, if pump 24 is provided in supply path 23 as in the first and fourth embodiments, used is a pump which is able to feed ink through supply path 23 when the pump is deactivated, or a by-path 23a, as in the fourth embodiment should be employed.

Based on the inkjet recording apparatus related to the present invention, even in the case of the ink supplying system which is sealed from atmospheric air, an ink supplying system in which ink, directed to waste tank 21 through ink wasting flow path 27, is switched to sub-tank 40 by changeover valve 26, a great deal of air can be prevented from returning to ink tank 20K, so that any dissolved air in the ink can be maintain to a predetermined amount. Further, while ink is ejected from the inkjet heads, generation of air bubbles due to cavitation is prevented, and then it becomes possible to-provide the inkjet recording apparatus which stably ejects ink from the heads. In addition, comparing to the prior art wherein ink in the inkjet heads is pressurized and ink in the nozzles is suctioned and a great amount of ink is wasted, the present invention can stably eject ink, while greatly reducing the amount of wasted ink.

What is claimed is:

1. An inkjet recording apparatus, comprising:
a recording head including plural nozzles to jet ink and a ink chamber communicating with each of the plural nozzles;
a hermetically closed ink storage tank;
a hermetically closed ink supplying flow path to supply ink to the ink chamber;
a hermetically closed ink discharging flow path to discharge ink from the ink chamber;
a waste ink tank to store waste ink; and
a changeover section to select a destination of the ink discharged through the ink discharging flow path;
wherein the destination is either the ink tank or the waste ink tank.

2. The inkjet recording apparatus in claim 1, further comprising:
a recording head having two ink chambers:
a hermetically closed ink supplying flow path to supply ink to one of the ink chambers; and
a hermetically closed ink discharging flow path to discharge ink from the other ink chamber.

3. The inkjet recording apparatus in claim 1, wherein the ink tank is a sub-tank.

4. The inkjet recording apparatus in claim 1, wherein the ink tank is a flexible container.

5. The inkjet recording apparatus in claim 1, wherein the ink supplying flow path includes an ink transportation section to transport ink.

6. The inkjet recording apparatus in claim 1, wherein the ink discharging flow path includes an ink transportation section to transport ink.

7. The inkjet recording apparatus in claim 6, wherein the ink transportation section of the ink discharging flow path reversibly transports ink.

8. The inkjet recording apparatus in claim 1, further comprising:
an ink recovering section for recovering ink ejected from the plural nozzles; and
a waste ink tank for containing the ink recovered by the ink recovering section.

9. The inkjet recording apparatus in claim 8, wherein the waste ink tank for containing the ink discharged through the ink discharging flow path and the waste ink tank for containing the ink recovered by the ink recovering means are common.
